(19) United States
(12) Patent Application Publication
(10) Pub. No.: US 2003/0051345 A1
(43) Pub. Date: Mar. 20, 2003

(54) Egg dicing board

(76) Inventors: Wai Ying Yeung Louie, New Carrollton, MD (US); Chun Chin Louie, New Carrollton, MD (US)

Correspondence Address: Wai Ying Yeung Louie, 8503 Legation Rd., New Carrollton, MD, 20784, US

(21) Appl. No.: 09/955,280

(22) Filed: Sep. 18, 2001

(51) Int. Cl. B26B 3/00

(52) U.S. Cl. 30/114; 30/117; 30/303

(57) ABSTRACT

An egg dicing board comprising of a rectangular framework having a crisscrossed grid welded onto the top of the framework. On the underside a number of projecting loops, which can be made of various sizes and shapes, stabilizes the egg dicing board over the rim of an open container. The board also provides a contoured handgrip for increased control. The egg to be diced is placed over the grid, and is forced through by applying downward pressure with the palm of a hand. The diced egg drops directly into a receptacle below and is ready for use.

### BACKGROUND OF INVENTION

1. Field of Invention

This invention relates to, in general, hard-boiled egg dicing devices, and in particular, to devices capable of expedient operation, and is suitable for restaurant and food facility usages.

2. Description of Prior Art

Many traditional egg dicers and slicers comprise of a support member and a hinged cutting frame. In order to dice or slice an egg, the upper and lower members must be pressed together to force an egg to pass through the cutting wires. For example, U.S. Pat. No. 3,800,649 discloses a device for slicing an egg vertically and horizontally in separate steps. U.S. Pat. No. 4,095,339 discloses a hand held device for slicing an egg by pressing the upper pusher member into the wire slots of the lower main body. U.S. Pat. No. 4,852,256 discloses a hand held device for slicing an egg by pressing the wired upper member against the grooved base member. As does U.S. Pat. No. 4,937,938 discloses a hand held device for slicing an egg by squeezing the upper and lower hinged arms together, while U.S. Pat. No. 5,749,145 discloses a device for cutting an egg into slices or pieces with a hanged upper wired frame and a grooved lower base.

However, none of them provide an egg dicer that is capable of expedient and efficient operation, rugged in construction, easy to use, simple in design, dishwasher-safe and easy to clean after use.

### SUMMARY OF THE INVENTION

The object of the invention is to provide a one-piece construction egg dicing board suitable for food facilities that have continuous demands for large quantities of diced egg at locations such as salad bars in restaurants, cafeterias and the like.

The egg dicing board comprises of a framework including a rectangular exterior support frame having a handgrip at one end and an interior support ring. The rectangular framework also has a bridge-like member connecting the exterior supporting frame and the interior ring at each of the four corners to form a flat surface for supporting a dicing grid. Each bridge-like support provides a number of loop-like curved legs on the underside, whereby they function as stable grooves to prevent the egg dicing board from shifting on the container during operation. The dicing grid, which is welded onto the framework's flat surface, comprises of an upper layer and a lower layer of wires that perpendicularly intersect each other. Furthermore, the lower layer of the cutting wire also provides grooves at all intersections where the corresponding upper cutting wires meet to form a flat surface. The groove-fitting feature at the intersections of the cutting wires is important because a flatter surface provides a more precise edge for dicing an egg. Both layers of the cutting grid are made from a single continuous dicing wire having alternating U-turns at all ends. Hence a cutting grid having U-turn sidings prevents the hand from accidental injury. In operation, the egg dicing board is first placed atop an open container in which the diced egg will be collected. With one hand holding the egg dicing board's handle and the S-shaped crossbar retained on the rim of the container, the egg dicing board is ready for action. The cooked egg is placed over the center of the cutting grid, and is forced through the grid by applying pressure with the palm of the other hand; and any egg remaining from the previous egg can be pushed down by the next one or completely by the palm of the hand. This operation can be repeated continuously and rapidly until the last egg is finished.

According to the present invention the egg dicing board is generally manufactured of stainless steel rods and wires welded together to form a one-piece metal grid. The primary object of the present invention is to provide an efficient egg dicer that is fast in operation.

Another object of the present invention is to provide an egg dicer that is rugged in construction, omitting any moving part that might break down in over time in usage.

Another object of the present invention is to provide an egg dicer suitable for use on the open top of containers made of various sizes and shapes.

Another object of the present invention is to provide an egg dicer that is efficient and easy to use.

Another object of the present invention is to provide an egg dicer that can be used with either a right hand or a left hand.

Still another object of the present invention is to provide an egg dicer that is dishwasher-safe and easy to clean after use.

### BRIEF DESCRIPTION OF THE DRAWINGS

FIG. 1 is a perspective view of an egg dicing board of the present invention in use, showing a hard-boiled egg being pressed down through the grid by the palm of the operator's hand into a round container below.

FIG. 2 is a perspective view of an egg dicing board of the present invention illustrating the S-shaped cutting wires and the supporting framework before they are welded together. The illustration also includes an optional handgrip that can be attached onto the handle of the dicing board.

FIG. 3 is a perspective view of an alternate embodiment of the present invention, showing an under-laying grooved cutting wire.

FIG. 4 is a perspective view of an egg dicing board of the present invention having an optional handgrip attached to it.

FIG. 5 is a perspective view of an alternate embodiment of the present invention having a grooved cutting grid.

FIG. 6 is a close-up perspective view of the cutting grid of the alternate embodiment of the present invention, showing the upper cutting wires corresponding to the lower layer cutting wire's grooves at the intersections.

FIG. 7 is an enlarged cross-sectional view of the cutting grid at an intersection of FIG. 6.

FIG. 8 is a perspective view of an egg dicing board resting on the open rim of a cylindrical container.

FIG. 8 is a perspective view of an egg dicing board resting on the open rim of a square-shaped container.

### DETAILED DESCRIPTION OF THE INVENTION

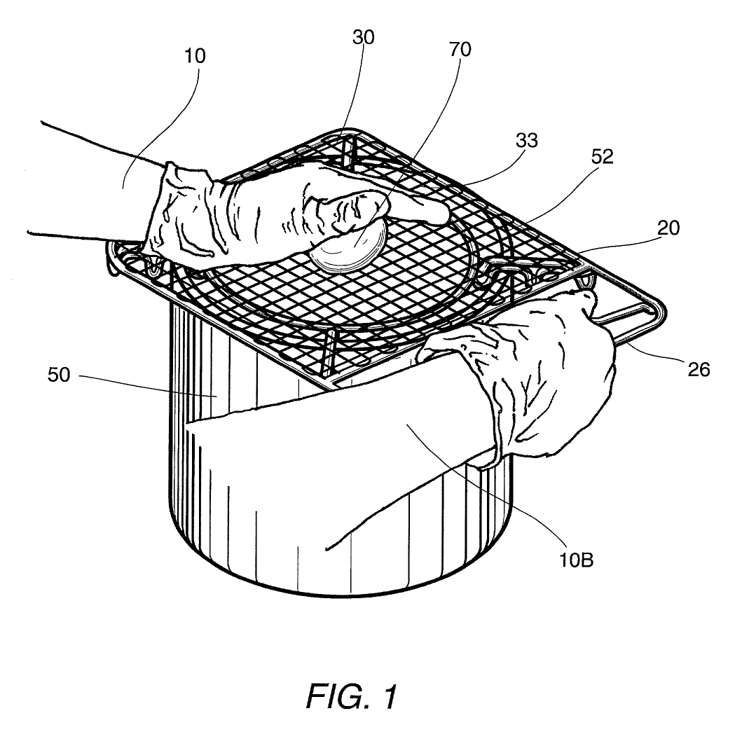

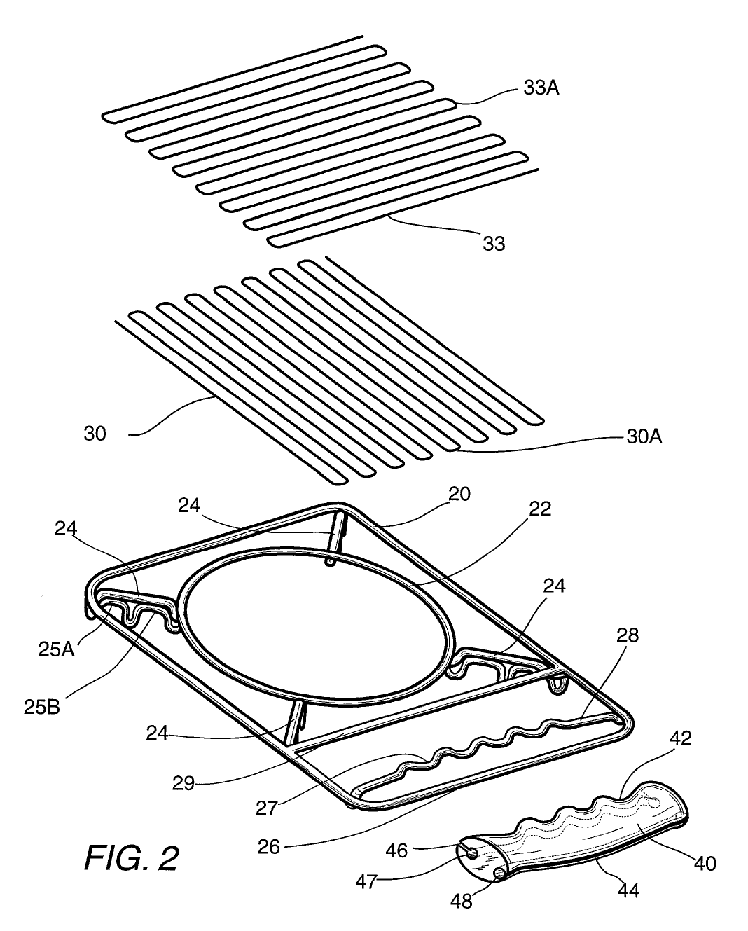

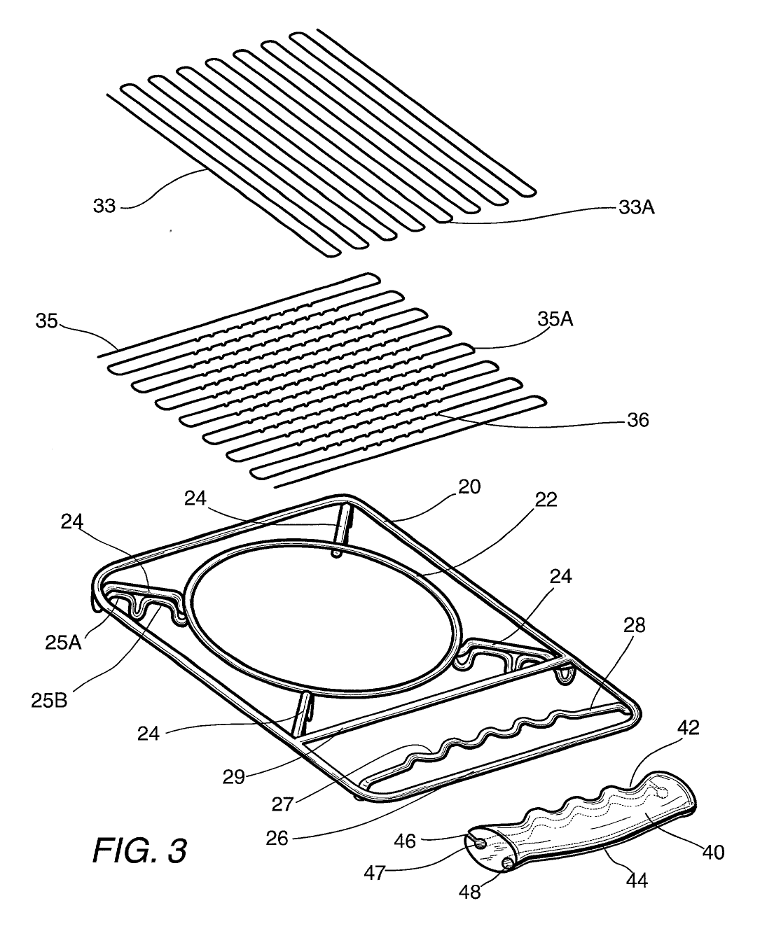

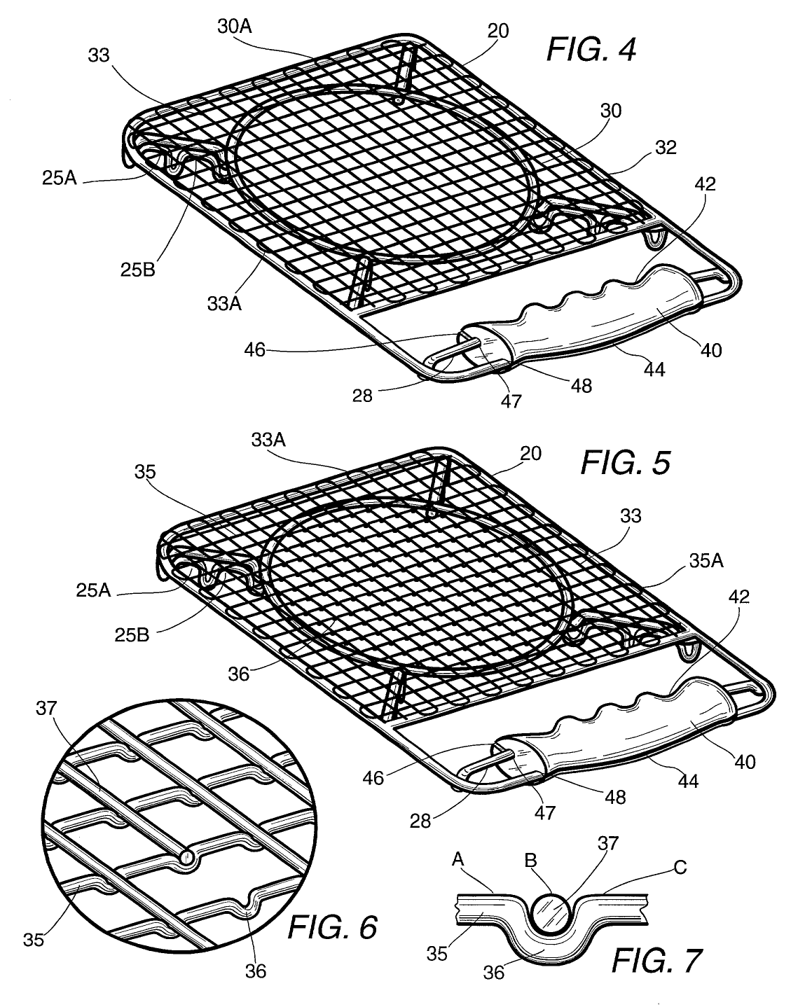

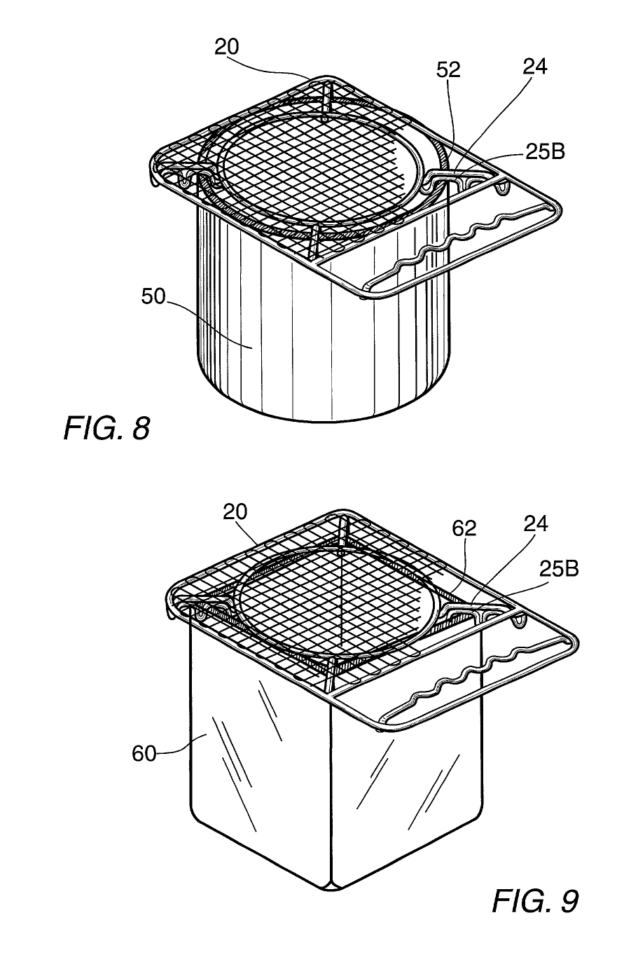

The egg dicing board of the present invention can be constructed by welding rods and wires made of stainless steel. Referring to FIGS. 2 and 4, the egg dicing board of the present invention includes a rectangular support frame 20 having intersecting wires 33 and 30 welded on the framework's upper surface. The framework also includes an inner supporting ring 22, connected by a bridge-like supporter 24 at each of the frame's four corners. The framework is further strengthened by a cross bar 29 connecting across the rectangular frame to form a square-shaped supporting closure. As seen in FIG. 2, the bar under the bridge-like supporter 24 is curved into two opening loops 25A and 25B. The curved shape loops 25A and 25B stabilizes the egg dicing board onto the rim of an open container of various sizes and shapes such as a round-shaped container 50 in FIG. 8 and a square-shaped container in FIG. 9. As illustrated in FIG. 8, the open loop 25B support 24 is retained on the rim 52 of the container 50 and the same open loop 25B also can fit onto the rim 62 of a square-shaped container 60. The rectangular framework also provides a handle or handgrip for gripping at one end of the frame. The handle can be held by the operator's other hand to further secure the egg dicing board over the container as illustrated in FIG. 1. The handgrip portion is formed near the side bar 26 by adding an S-shaped crossbar 28, where the S-shaped crossbar 28 provides curves 27 to fit the contour of the fingers for a better grip. In order to provide a more comfortable and firmer grip of the dicing board, an optional molded handle 40 can be inserted between S-shaped crossbar 28 and side bar 26, in such a way that the slot 47 of handle 40 aligns with curved bar 27 with opening 46 while slot 48 aligns with side bar 26 with opening 44 as illustrated in FIG. 4. Referring to FIG. 2, the cutting grid consists of two perpendicular intersecting layers of S-shaped wires 33 and 30. The dicing grid is welded onto the framework's upper surface that includes the rectangular frame 20, the inner supporting ring 22 and the topside of the four bridge-like supporters 24. Welding also applied to all the other intersections and contact points throughout the whole structure to form a rigid construction. As seen in FIG. 2, both dicing wires 33 and 30 are made from a single S-shaped wire having alternate U-shapes 33A and 30A at the turning ends. The purpose of a cutting grid having U-shaped ends around the outer edge of the board is to provide a safer and smoother border to prevent the hand from accidental injury. Referring to FIGS. 3, 4, 5 and 6, which are the illustrations of an alternate embodiment of the present invention having a cutting grid with a layer of grooved dicing wire under-laying the upper one. As illustrated in FIG. 6, the lower wire 35 provides a groove 36 to allow the upper wire to sit flush 30 at each intersection in such a manner that the top sides A and C of lower cutting wire 35 and the top side C of upper cutting wire 30 form a flat dicing surface as shown in FIG. 7. A dicing grid having a flat surface provides smoother operation for the hand as well a more even dicing surface on the dicing board.

FIG. 1 illustrates the operation of the present invention of the egg dicing board. With one of the operator's hands 10B holding the handle 26 of the egg dicing board over the top of an open round-shaped container 50, a shelled hard-boiled egg 70 is placed at the center of the dicing board and is then pressed through the dicing grid by the operator's other hand 10A. The diced egg 70 falls through the cutting grid and is collected by the container 50 below.

The detailed description above in connection with the appended drawings is intended as a description of the present preferred embodiment of the invention, and is not represented as the only form in which the present invention may be constructed or utilized. The description sets forth the functions and operating the invention in connection with the illustrated embodiment. It is to be understood, however, that the same of equivalent functions and sequences may be accomplished by different embodiments that are also intended to encompass the spirit and scope of the present invention.

We claim:

1. A one-piece construction egg dicing board to be used over the top of an open receptacle for dicing a shelled hard-boiled egg comprising of:
a rectangular support framework including exterior and interior supporting frames mounted on the top surface thereof;
a planar dicing means fixedly mounted on said rectangular supporting framework;
a handgrip extended from one end of said rectangular framework,
a number of horizontal bridge-like supports having an array of S-shaped loops provided on the underside of said supporting framework.

2. The egg dicing board of claim 1 wherein said rectangular supporting framework includes an rectangular exterior support frame and an interior support ring axially linked by a bridge-like supporter at each of the four corners to form a planar supporting surface, said bridge-like supporter provides an array of curve-shaped loops on the underside, whereby said curve-shaped loops are used for retaining purpose; said cutting means includes two layers of perpendicularly intersecting S-shaped dicing wires welded at the intersections to form a cutting grid, wherein said S-shaped dicing wire is defined as a continuous wire having alternating U-shaped ends, whereby said U-shaped turn provides a smoother edge to avoid accidental injury; said handgrip extended from one end of said rectangular framework includes a curved crossbar, whereby said curved crossbar provides a curved contour for better gripping for the fingers;

3. The egg dicing board of claim 2 wherein said dicing grid includes a lower grooved dicing wire, wherein said lower grooved dicing wire provides corresponding grooves to fit said upper dicing wire at each intersection to form a flatter cutting surface, wherein said flat dicing surface refers to having both top sides of said lower cutting wire and top of said upper cutting wire lining up flush, whereby said flat dicing surface provides a smoother dicing grid.

4. The egg dicing board of claim 2 wherein said rectangular framework includes a number of downwardly extending members, whereby said extending members provide loops to better stabilize the dicing board.
